(19) United States
(12) Patent Application Publication
(10) Pub. No.: US 2011/0213684 A1
(43) Pub. Date: Sep. 1, 2011

(54) FINANCIAL MANAGEMENT SYSTEM

(75) Inventor: Jeremy Tait, Edinburgh (GB)

(73) Assignee: THE ROYAL BANK OF SCOTLAND, Edinburgh (GB)

(21) Appl. No.: 12/999,234

(22) PCT Filed: Jun. 16, 2009
(86) PCT No.: PCT/EP2009/057431

§ 371 Date: May 9, 2011

(30) Foreign Application Priority Data
Jun. 17, 2008 (GB) 0811059.5

(51) Int. Cl. G06Q 40/00

(52) U.S. Cl. 705/30; 705/39

(57) ABSTRACT

The invention provides a financial management system for use in managing a bank account, wherein the bank account is sub-divided into at least two credit containers, each credit container corresponding to a category associated with an activity relating to funds available in said account, wherein each said category is predetermined such that a uniform set of credit containers apply to all customers having a said bank account. According to the invention, a plurality of credit containers, or pots, is associated with a given account; since these pots are predetermined and specified by, e.g. the provider of the bank account, the functionality and services associated with a given account, in terms of transferring funds between credit containers, can be standardised for a given customer base and require less user intervention than do known financial management systems.

### FIELD OF THE INVENTION

The present invention relates to a financial management system and account operation apparatus for managing transactions relating to a bank account, and is particularly, but not exclusively related to managing transactions within a single bank account.

### BACKGROUND OF THE INVENTION

One of the traditional approaches to personal financial management has been to allocate different accounts for different purposes: for example, typically borrowing and saving activities are associated with different accounts. In these known arrangements an individual's income may be paid into a general purpose account such as a current account and separate accounts maintained for savings and loans. Credit cards traditionally also have separate accounts according to which provider issues them.

Whilst separate accounts appear to provide a user with a convenient and clear way of managing incoming funds, account holders tend to find it difficult to manage and track transactions and total expenditure. This approach to account management is still applied to modern financial services that are accessible remotely, such as telephone and Internet banking.

Prior art systems such as that described in United States patent application having publication number US2003009402 provide a means of integrating all transactions within a single account (the so-called “One Account”); these transactions include mortgage repayments, current account funds, savings account and the different kinds of costs can be presented to the account holder separately via a graphical interface. The various cost pots are user configurable, and enable a given customer to tailor the account to reflect and report on individual types of costs. The benefit of such an account is that account holders can increase interest payments on their mortgage when their current account spend pot is in credit because the account provides full visibility of the funds available across the full spectrum of incomings and outgoings. However, these benefits have commensurate drawbacks: when reviewing their balance at an ATM, and assuming the account holder to have a mortgage loan of sizeable magnitude, the account will indicate that the customer is in debt.

Another prior art system is described in United States patent application having publication number US20070185896, which describes a system that enables users to create customised folders within a customer account so as to avoid the customer having to create new accounts. These folders are created by the user without direction and thus entirely on an ad-hoc basis, and require significant overhead and expertise in account management on the part of the account holder.

### SUMMARY OF THE INVENTION

In accordance with a first aspect of the present invention, there is provided a financial management system according to claim 1; preferred features of embodiments of the invention are set out in dependent claims.

With embodiments of this first aspect of the invention, a plurality of credit containers, or pots, is associated with a given account; these pots are predetermined and specified by, e.g. the provider of the bank account. As a result, the functionality and services associated with a given account, in terms of transferring funds between credit containers, can be standardised for a given customer base. This provides benefits over arrangements such as that described in US20070185896, since it does not require the user to set up the respective pots and have to configure transfers and balance inquiries from scratch.

In one arrangement, each of the credit containers is associated with different user activities on the basis of preconfigured activity rules: one such credit container can be associated with all debit transactions for a given customer, specifically debit transactions that are foreseeable, while another such credit container can be associated with all non-foreseeable transactions such as cash withdrawals, debit card transactions and cheque payments. In this way, debit transactions are assigned to one of the credit containers, thereby providing a means of effectively filtering debit transactions on the basis of user activity. As a result, customers are provided with increased visibility of how their incomings relate to their spending and savings habits and needs, whilst assisting customers to achieve improved management of their personal finances.

Conveniently, the credit containers are arranged to have an associated balance, and each credit container has a record of outgoings associated with the corresponding activities. Further, any given credit container can be configured to hold a record of said outgoings within a configurable period.

According to a second aspect of the present invention there is provided account operation apparatus for managing transactions relating to a bank account according to claim 7. Preferred features of the account operation apparatus are set out in claims dependent on claim 7.

The account operation apparatus can be arranged to transfer a proportion of incomings to each said credit container on the basis of an allocation algorithm, and the allocation algorithm can be configured according to the proportions. In one arrangement, the accounting means (or function) is responsive to input received via the interface means (or function) specifying proportions of incomings to be transferred to a respective credit container. In another arrangement, the proportions are predetermined. In a yet further arrangement the proportions can be evaluated on the basis of expected outgoings, specifically foreseeable debit transactions, within a specified period. The respective proportions can be modified on the basis of the evaluated outgoings and expected incomings, and amounts retained in other containers modified accordingly.

The account operation apparatus can provide an interface means (or function) arranged to cooperate with client software so as to provide a report of the availability of funds in the bank account. In one arrangement, the availability can be reported as balances associated with individual credit containers and thus as a function of financial activities associated with respective credit containers. The client software includes user interface means (or function) that presents the user with a variety of selectable and editable portions, thereby enabling the user to manually configure transfers between respective pots.

Preferably the apparatus further comprises alert generating means (or function) arranged to monitor balances of respective credit containers and to automatically generate an alert for transmission to the customer in the event that a given balance falls below a specified threshold. Such alerts can be transmitted using the Short Messaging Service (SMS) or via Wireless Access Protocol (WAP) messages, e-mails and the like according to preferences specified by the customer.

According to a further aspect of the present invention there is provided a method, computer software and a distributed computer system arranged to perform and provide the afore-described functionality.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing a distributed system in which embodiments of the invention operate;

FIG. 2 is a schematic diagram showing an account holder's record held in a database, together with fields thereof;

FIG. 3 is a schematic diagram showing the server system of FIG. 1 according to an embodiment of the invention;

FIG. 4 is a schematic diagram showing output of a rendering software application operating on one of the terminals shown in FIG. 1;

FIG. 5 is a schematic diagram showing further output of the rendering software application operating on one of the terminals shown in FIG. 1;

FIG. 6 is a schematic diagram showing an alternative form of output generated by the rendering software application operating on one of the terminals shown in FIG. 1; and

FIG. 7 is a schematic diagram showing yet further output of the rendering software application operating on one of the terminals shown in FIG. 1.

### DETAILED DESCRIPTION OF THE INVENTION

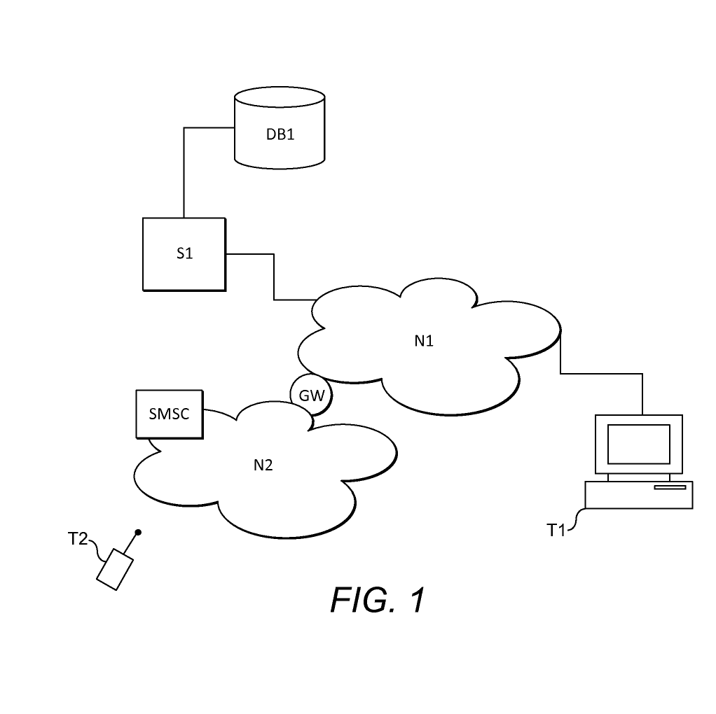

As described above, embodiments of the invention are concerned with a financial management method and system for managing a bank account, where the bank account is sub-divided into a plurality of predetermined credit containers, or pots. A detailed description of the configuration of such a bank account, together with a description of methods and processes required to manage funds within the account will be described in detail below, but first an overview of an environment in which embodiments of the invention can operate will be described with reference to FIG. 1.

In this example, a customer uses a client terminal such as personal computer T1 or a mobile terminal T2 to access a bank account via public networks such as the internet N1 and/or via a Public Land Mobile Network (PLMN) N2. The account may be held remotely, and be accessible through a customer gateway and/or database DB1 connecting to a server system S1 of a financial institution which provides the actual banking account facilities. The customer database DB1 can comprise a database holding customer data, which is for use by the banking account facility and indeed by institutions that cooperate with the banking account facility in the transfer of funds to and from a given bank account. Each client terminal T1, T2 is equipped with software (to be described in detail below) that enables the terminal to remotely interrogate the server system S1 and thereby acquire account information; for example the customer can check account details such as account balance and transactions. Additionally, a customer may amend billing details from a given account such as direct debits and standing orders, and configure respective credit containers associated with their bank account, as will be described in more detail below.

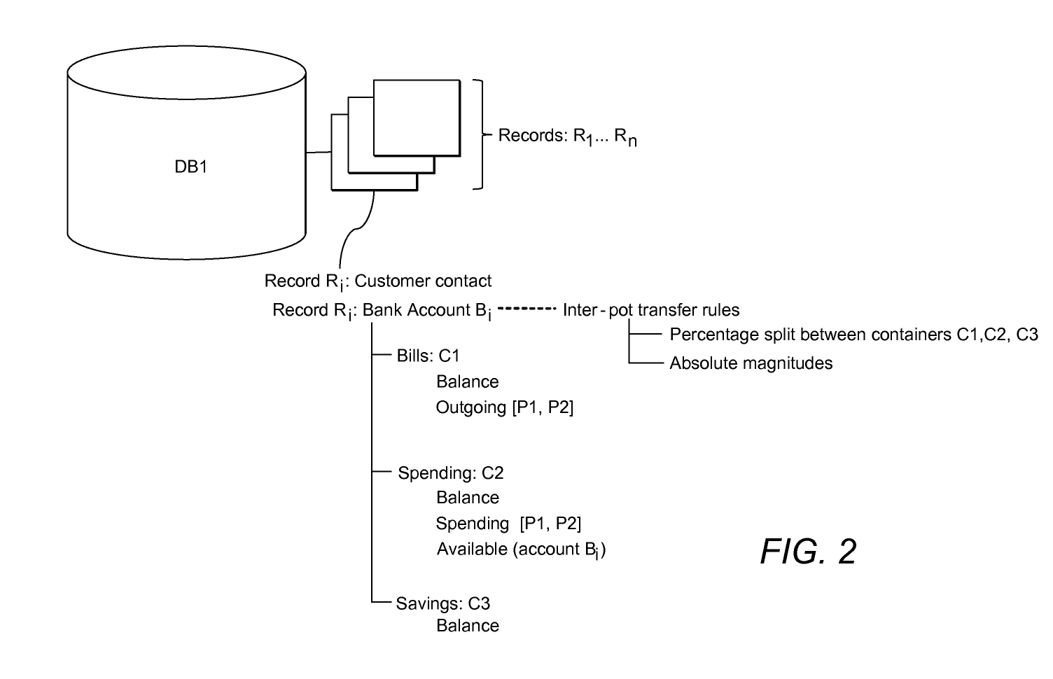

Turning to FIG. 2, each record Rᵢ in the customer database DB1 has a plurality of account attributes, and in accordance with embodiments of the invention, these attributes include containers, or pots, corresponding to a given account. The mapping between bank account and containers is standardised for all account holders, which is to say that all customers have the opportunity to distribute their incomings between pre-designated and activity-related containers. In the example shown in FIG. 2, there are three containers, one relating to bills C1, one relating to spending C2, and a further relating to savings C3. A particular feature of this embodiment is the designation of all debit related transactions to a given container, in this case bills container, C1. Typically this container will be assigned all foreseen outgoings such are effected via standing orders and direct debits, and the bank account may have various transaction-related constraints associated therewith. Examples of such constraints include a rule specifying that card and cheque payments, which are typically unforeseen, cannot be attributed to the bills container C1. The spending pot C2 can be used to associate all non pre-configured transactions such as cash withdrawals, payments from the account via debit cards and cheques associated with the account, and any lump sum incomings to the account as a whole. The savings pot C3 can be used for long-term or regular deposits of funds relating to incomings to the account, and can additionally be associated with savings held with third parties, such as ISA savings accounts according to parameters specified by the account holder.

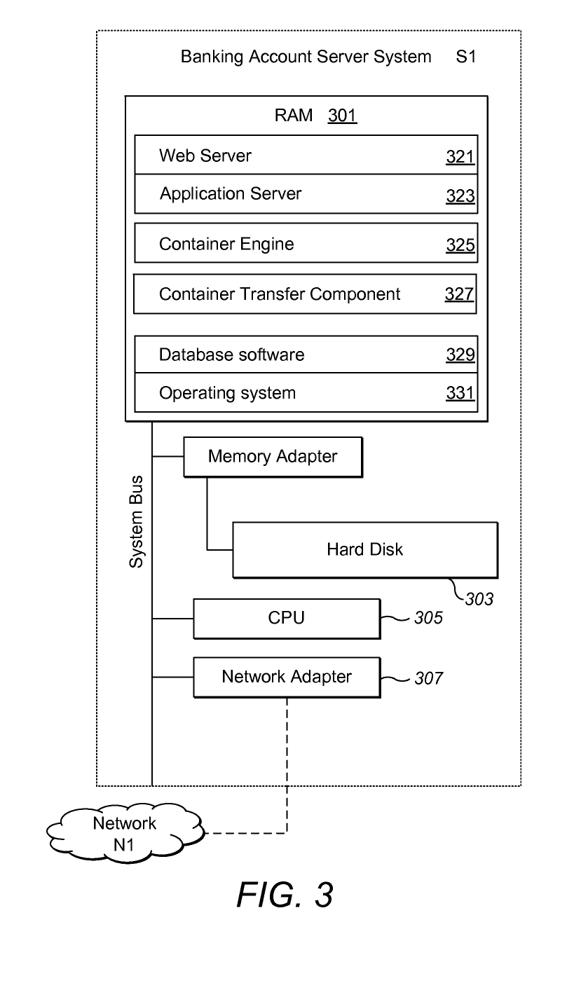

Turning now to FIG. 3, configuration of embodiments of the invention, implemented as software components running on server system S1, will be described. Typically the server system S1 will comprise an array of processing components, and functionality will be distributed between the processing components. Accordingly, while FIG. 3 only shows a single server, it will be appreciated that this is for the purposes of clarity only. The server S1 comprises conventional operating system and storage components (system bus connecting the central processing unit (CPU) 305, hard disk 303, random access memory (RAM) 301, I/O and network adaptors 307 facilitating connection to user input/output devices interconnection with other devices on the network N1). The Random Access Memory (RAM) 301 contains operating system software 331 which control, in a known manner, low-level operation of the server S1. The server RAM 317 also contains application server software 323 and web server software 321, database software 329 for retrieving account, container and user data securely from the database DB1, a container engine 325 and container transfer component 327.

The bespoke software components 325, 327 are responsible for managing the division of funds within a given bank account Bᵢ into respective containers C1, C2, C3 associated with the account in response to events such as receipt of incoming funds and/or on the basis of other predefined or user-defined events. The allocation of funds incoming to the account Bᵢ between the respective pots C1, C2, C3 can be preconfigured by the container transfer component 327 and/or they can be supplemented or overridden by user input.

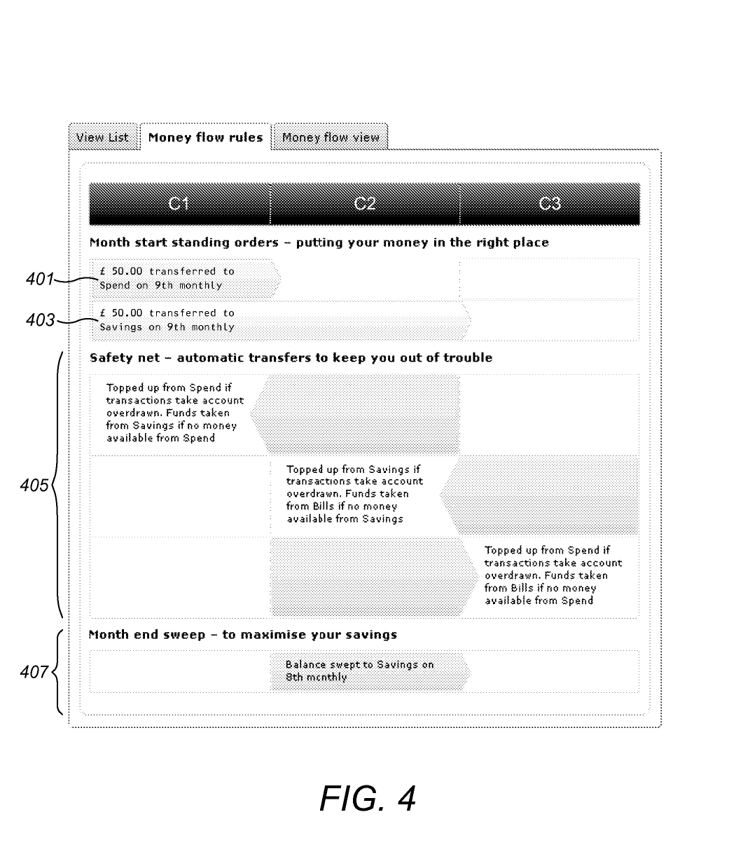

FIG. 4 shows output of a rendering client software application (not shown) running on a user terminal T1, specifically a representation of rules governing the transfer of funds between pots C1, C2, C3 for a given account. In this example, incoming funds are deposited into the bills pot C1 in the first instance; as can be seen, the rules specify that a first preconfigured amount (in this case £50.00) 401 is transferred to the spend pot C2, and that a second preconfigured amount (in this case £530.00) 403 is transferred to the savings pot C3, on a certain date of the month. It will be appreciated that funds are preferably deposited into the bills pot C1 in the first instance because some bills are payable at intervals other than monthly (e.g. quarterly, yearly); as a result, for most users the amounts required to settle these foreseeable outgoings are not constant for any given month.

These discrete transfer rules are supplemented by somewhat continuous inter-pot operations, governed by so-called “safety net” rules 405, which control automatic transfer of funds between pots in the event that the amount of funds in a given pot reaches, or goes below, a specified threshold. These transfer safety-net rules 405 are designed to distribute funds within the account by moving funds between the respective pots so as to ensure funds are available for each type of outgoing payment event.

In another arrangement, funds are transferred between credit containers C1, C2, C3 as percentages of funds incoming to the bank account Bᵢ and the allocation or percentages, between the respective containers, can be configured by the user or effected according to predetermined rules.

In addition, or as an alternative, in view of the fact that the account holder is somewhat obliged to honour his preconfigured outgoings, a projected magnitude of outgoings is evaluated and used to provide a percentage of expected incomings that should be retained within the bills pot C1. For example, if the container transfer component 327 determines that a certain magnitude of funds is due out of the account between a period overlapping with receipt of incoming funds, the magnitude of these funds, as a percentage of the expected incomings during this period, can be evaluated and used to adjust previously specified percentage allocations to respective containers C1, C2, C3. In one arrangement, if the projected percentage of incomings associated with bill payments exceeds that retained within the bills container C1 for a previous period, the percentage allocated to the savings pot C3 is decreased by a commensurate account so as to enable a greater percentage to be retained within the bills pot C1. Alternatively the amount allocated to the spending pot C2 can be decreased accordingly, or the required decrease is split between the two other containers C2, C3 in accordance with a specified distribution.

As described above, customer terminals T1 and T2 are configured to view their account information locally on client software running on the associated terminals. In one arrangement, the terminal T1, T2 is configured with a browser and an applet that cooperates with the web server 321 to request and retrieve data corresponding to respective containers (or pots), and thereby display the status of the pots C1, C2, C3 and the rules governing transfer of funds therebetween (such as is shown in FIG. 4, described above). In another arrangement the web browser running on terminals T1, T2 is configured to run various Java Script code and thereby communicate with the web server 321 of the server 51 so as to retrieve container-specific data from the customer database DB1 and transmit container-specific and account-specific transfer requests. In the case of this second arrangement, the web server 321 is configured with a bespoke Servlet™ which communicates with the scripts running within the terminal browser using HTML and XML, preferably using Ajax™.

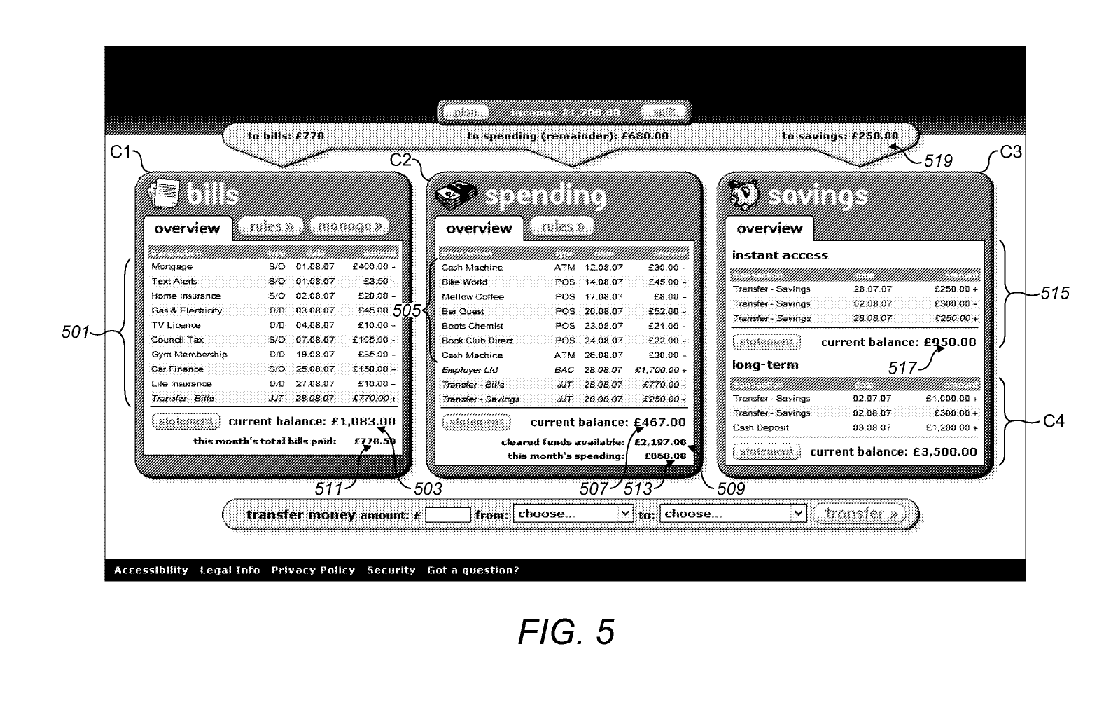

FIG. 5 is a screen shot showing a further rendering operation associated with the client rendering software introduced above in conjunction with FIG. 4; this rendering operation relates to the display of respective containers C1, C2, C3 and balance/account activity data associated therewith. As can be seen from the Figure, the bills container C1 lists outgoing standing order and direct debit payments (i.e. foreseen payments) 501, together with a balance 503 for the bills pot C1, this having been derived from the account record information stored in the customer database DB1. In relation to the spending container C2, outgoing, non-foreseen, payments 505 are listed, together with associated balance information 507. In this embodiment the funds available from the account as a whole 509 is displayed in association with the spending container C2. Each of the containers C1, C2 also displays an amount of funds 511, 513 that have been deducted from a respective container C1, C2 during a specified period (in this case the current month). A first savings pot C3 associated with so-called instant savings lists incoming transfers 515, together with a balance 517 associated therewith, as does a second, long-term savings pot C4 (in FIG. 5 this is shown as a part of the first savings pot C3). In addition the rendering operation provides a summary 519 of the absolute magnitude of incoming funds most recently allocated to respective pots, this having been calculated by the container transfer component 327 on the basis of previously configured inter-pot transfer rules.

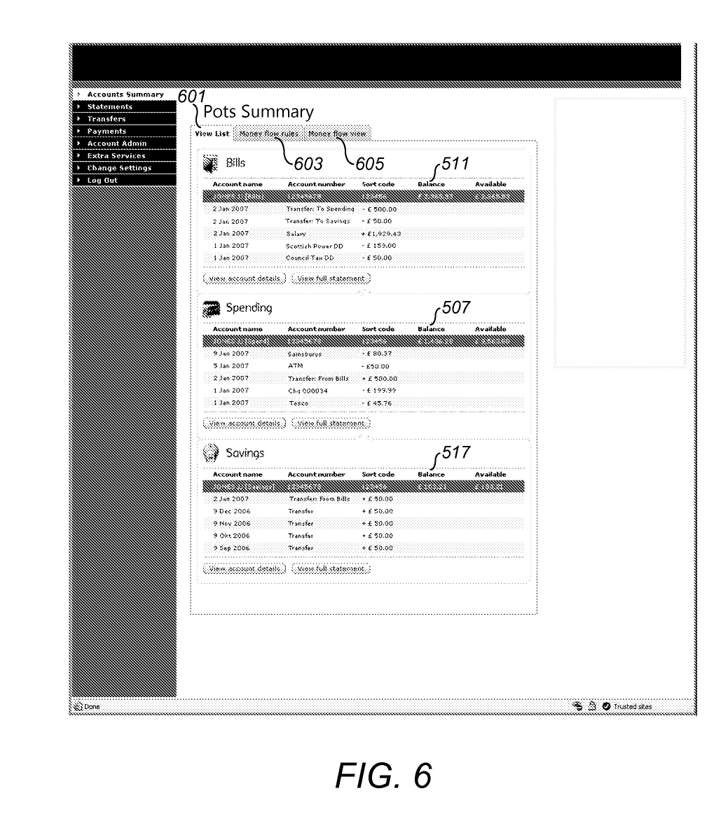

FIG. 6 shows an alternative screen shot generated by the rendering client software, where information relating to three exemplary pots C1, C2, C3 is presented as a list. The rules governing transfer of funds between the pots can be accessed by appropriate selection of tabs 601, 603, 605; for example, selection of rules tab 603 causes the display and rules shown in FIG. 4 to be presented.

The rendering operation also provides various user-selectable and user-editable portions, identifiable from text such as “transfer”, “manage”, “rules” and “statement”. These enable the user to manually configure the transfer of money between pots C1 . . . C4 and to configure the rules that control automatic transfer of a proportion, or an absolute magnitude, of incomings to respective pots, as is shown in FIG. 4.

Any rules or transfers specified by the user via the rendering client software are communicated to the container engine 325 via the web server 321 and stored in the database DB1, specifically in the customer record Rᵢ shown in FIG. 2, for subsequent use by the container transfer component 327 and in relation to any later account queries requested by the user.

Turning back to FIG. 3, the container engine 325 can be configured to monitor the balance of respective containers C1 . . . C4 against predetermined thresholds (which may be either an upper or a lower limit that is preset with respect to a given container), and automatically generate alerts for transmission to the account holder to a contact number held in the customer record Rᵢ when the threshold(s) is/are reached. These alerts can be sent via the Short Messaging Service via the SMSC shown in FIG. 3; the threshold for triggering such alerts can be preset for all customers or it can be manually set by individual users via the client rendering software.

In addition, the container engine 325 can be configured to send messages relating to the collective balance of two or more containers C1 . . . C4, as specified by the user. For example, the user may configure their account so as to receive a balance alert, and indeed set a threshold, for the bills and spend pots C1, C2 collectively. In addition, the user could configure the container engine 325 to send a balance alert when their collective savings pots C3, C4 reach a specified threshold. Further, the container engine 325 could be configured to generate messages in the event that funds are automatically swept between pots, or indeed to request permission from the user to sweep funds according to the safety net rules 405 and/or the end of month sweep rules 407. In the latter case, the container engine 325 would be configured to engage in a dialogue with the user according to a predetermined question/answer template and action the rules 405, 407 in dependence on the response received from the user.

Additional Details and Modifications

Whilst in the above embodiments, movement of funds between pots is configured according to safety net rules 405 shown in FIG. 4, the account could alternatively be configured so as to disable any automatic transfer between pots and instead rely on the alerting mechanism described above; in such an arrangement, funds would only be transferred in response to manual movement of funds between the containers C1, C2, C3 by the user.

Whilst the above embodiment describes a single banking account having a plurality of credit containers, it is to be understood that any number of banking accounts could have a plurality of credit containers associated therewith. In addition, or as a further alternative, embodiments of the invention could be used in conjunction with an account such as a mobile phone account, for which credit is used to buy different types of network resources; or diverted into one or more funds, for which credit is associated with different types of investments such as commodities, stocks, shares, bonds etc.; or in combination with accounts such as credit accounts, particularly if the credit card provider is the same entity as that providing the bank account.

In the above embodiments, the container transfer engine 327 transfers funds between pots C1 . . . C4 according to user-configured or preset transfer rules; as an addition or an alternative, the container transfer engine 327 can be arranged to automatically transfer any funds remaining in one or a selection of non-savings containers C1, C2 to one of the savings containers C3, C4, as indicated in FIG. 4 as a “month end sweep”.

As is known, money held in savings accounts earn interest; the container transfer engine 327 could additionally be configured to transfer such earned interest to offset any loans associated with the account, such as a mortgage or other lump sum loans provided by a money lender (be that by the bank with whom the user has the account or a third party lender).

In the above embodiment, terminal T1 is a personal computer and communicates with the server Si via fixed line communications links. However, terminal T2, which is a mobile station, could communicate with the server S1 via the radio network N2, which may be can comprise a licensed network portion (such as is provided by cellular networks using e.g. Global System for Mobile Communications (GSM) technology, Wideband Code Division Multiplex Access (WCDMA); Code Division Multiplex Access (CDMA), WiMax) and/or unlicensed network portions (such as is provided by Wireless LANs and Bluetooth technologies). The gateway GW can be a GPRS support node (GGSN) forming part of the mobile network N2. In the event that terminal T2 is only capable of processing and displaying WAP pages, translation of a web page output from the web server 321 can be performed by a device in the network or by suitable translation software running on terminal T2.

In the above embodiments, terminals T1, T2 log onto the web server 321 to retrieve account and pot details, and, via the client rendering software, can modify the rules governing the transfer of funds between pots. It will be appreciated that any such access will be performed via suitable security enabled protocols such as HTTPS, and that various authentication mechanisms will be employed to verify the user's access to the associated account details. In addition, or as an alternative, the user could configure a Google™ gadget (not shown) on his web browser, which is programmed to request balance information associated with the various pots C1, C2, C3, e.g. from the database DB1 using a minimum set of authentication credentials that the user has made available to the gadget. The gadget would also be arranged to include a selectable button which, when selected by the user, could route the browser software to the web server 321. In this way, any access to the account and pots therein would be under full control of the rigorous authentication procedures employed by server S1.

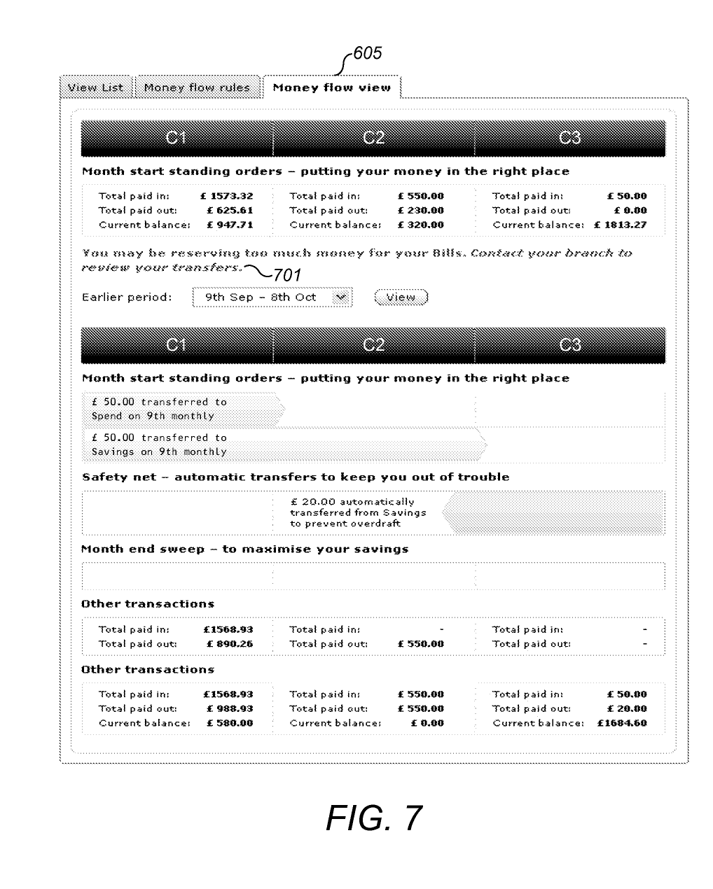

In addition to configuring an account with a plurality of predetermined credit containers, or pots, embodiments of the invention could be modified such that the container engine 325 is capable of providing recommendations to the user in relation to their inter-pot transfer rules. Specifically, the container engine 325 could monitor how the options configured by the user (or indeed those set up automatically and selected by the user) map to the actual spending and saving habits of the user, and output messages indicating potential changes to the current rules in place. Typically, the monitoring would be performed over a predetermined period, to be specified by the user; alternatively, the container engine 325 could be configured with various alert thresholds (e.g. a pot becoming overdrawn more than 2 months running; surplus funds in a given account over more than 3 months), and generate the output messages when the thresholds are met. FIG. 7 shows an example of such an output message 701, overlaid upon the screen associated with the money flow view tab 605.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A financial management system for use in managing a bank account, wherein the bank account is sub-divided into at least two credit containers, each credit container corresponding to a category associated with an activity relating to funds available in said account, wherein each said category is predetermined such that a uniform set of credit containers apply to all customers having a said bank account.

2. A financial management system according to claim 1, wherein each said credit container has a balance associated therewith.

3. A financial management system according to claim 1 or claim 2, wherein each said credit container has a record of outgoings associated with the corresponding activities.

4. A financial management system according to claim 3, wherein the credit container has a record of said outgoings within a configurable period.

5. A financial management system according to any one of the preceding claims, wherein said credit containers comprise a first credit container corresponding to all debit transactions for a given customer.

6. A financial management system according to any one of the preceding claims, wherein each said container has a set of rules associated therewith, said rules being for use by account operation apparatus when transferring incomings to the respective credit containers.

7. An account operation apparatus operable to implement bank account transactions for a plurality of customers, each said bank account being sub-divided into at least two credit containers, each credit container corresponding to a category associated with an activity relating to funds available in said account, wherein each said category is predetermined such that a uniform set of credit containers apply to all customers having an associated bank account, said account operation apparatus comprising:
transaction means for receiving, from the customer, instructions for transactions and allocating the instructions to one of the credit containers on the basis of the type of transaction specified in the instructions;
accounting means for updating balances associated with each said credit container in response to said transactions; and
interface means for reporting the credit containers and balances associated therewith, wherein the interface means is responsive to user selection so as to enable the user to manage said transactions associated with the credit containers.

8. An account operation apparatus according to claim 7, wherein the transaction means is arranged to receive instructions for debit transactions and to allocate the instructions to a first credit container, said first credit container being associated with all debit transactions for the customer.

9. An account operation apparatus according to claim 7 or claim 8, wherein said credit containers comprise a second credit container, said second credit container corresponding to transactions other than those that are configured via the interface means.

10. An account operation apparatus according to any one of claim 7 to claim 9, wherein the accounting means is arranged to transfer a proportion of incomings to each said credit container on the basis of an allocation algorithm.

11. An account operation apparatus according to claim 10, wherein the accounting means is responsive to input received via the interface means, said input specifying proportions of incomings to be transferred to a respective credit container, whereby to configure said allocation algorithm on the basis of the proportions.

12. An account operation apparatus according to claim 11, wherein the proportions are predetermined.

13. An account operation apparatus according to claim 12, wherein, for a given credit container, the accounting means is arranged to evaluate an expected amount of outgoings from the given credit container during a specified period, the accounting means being further arranged to modify the proportions on the basis of a relationship between the expected amount of outgoings and the incomings for the specified period.

14. An account operation apparatus according to any one of claim 7 to claim 13, wherein the interface means is arranged to report availability of funds in the bank account as balances associated with individual credit containers so as to report available funds as a function of financial activities associated with respective credit containers.

15. An account operation apparatus according to claim 14, the apparatus further comprising alert generating means arranged to monitor balances of respective credit containers and to automatically generate an alert for transmission to the customer in the event that a given credit container balance falls below a specified threshold.

16. An account operation apparatus according to any one of claim 8 to claim 15, wherein the apparatus is arranged to associate respective credit containers with different user activities on the basis of preconfigured activity rules.

17. An account operation according to claim 16, wherein the apparatus is arranged to associate foreseeable debit transactions with the first credit container.

18. An account operation according to claim 16, wherein the apparatus is arranged to associate non-foreseeable debit transactions with the second credit container.

19. A method for managing transactions relating to a bank account, the said bank account being sub-divided into at least two credit containers, each credit container corresponding to a category associated with an activity relating to funds available in said account, wherein each said category is predetermined such that a uniform set of credit containers apply to all customers having an associated bank account, the method comprising:
receiving instructions for transactions and allocating the instructions to one of the credit containers on the basis of the type of transaction specified in the instructions; and
updating balances associated with each said credit container in response to said transactions.

20. A method according to claim 19, further comprising providing output indicative of the credit containers and balances associated therewith.

21. A method according to claim 19 or claim 20, in which, responsive to receipt of instructions for debit transactions of a first type the method comprises allocating the instructions to a first credit container, said first credit container being associated with all debit transactions of the first type for the customer.

22. A method according to claim 21, wherein said debit transactions of the first type are foreseeable.

23. A method according to any one of claim 19 to claim 22, in which, responsive to receipt of instructions for debit transactions of a second type, different to said first type, the method comprises allocating said debit transactions of the second type to a second credit container, said second credit container corresponding to non-foreseeable debit transactions.

24. A method according to any one of claim 19 to claim 23, further comprising transferring a proportion of incomings to each said credit container on the basis of an allocation algorithm.

25. A method according to claim 24, including receiving input specifying proportions of incomings to be transferred to a respective credit container and configuring said allocation algorithm on the basis of the proportions.

26. A method according to claim 24, including evaluating an expected amount of outgoings from the given credit container during a specified period, and modifying the proportions on the basis of a relationship between the expected amount of outgoings and the incomings for the specified period.

27. A method according to any one of claim 19 to claim 26, further comprising monitoring balances of respective credit containers and generating an alert for transmission to the customer in the event that a given credit container balance falls below a specified threshold.

28. A computer program, or a suite of computer programs, comprising a set of instructions arranged to cause a computer, or a suite of computers to perform the method according to any one of claim 19 to claim 27.

29. A computer readable medium comprising the computer program according to claim 28.
